(19) United States
(12) Patent Application Publication
(10) Pub. No.: US 2014/0003049 A1
(43) Pub. Date: Jan. 2, 2014

(54) Luminaire

(71) Applicants: Toshiyuki Ishida, Yokosuka-shi (JP); Kunihiko Ikada, Yokosuka-shi (JP); Tomokazu Usami, Yokosuka-shi (JP); Kimihito Sato, Yokosuka-shi (JP); Li qui Fang, Hangzhou (CN); Li Bin, Hangzhou (CN)

(72) Inventors: Toshiyuki Ishida, Yokosuka-shi (JP); Kunihiko Ikada, Yokosuka-shi (JP); Tomokazu Usami, Yokosuka-shi (JP); Kimihito Sato, Yokosuka-shi (JP); Li qui Fang, Hangzhou (CN); Li Bin, Hangzhou (CN)

(73) Assignee: TOSHIBA LIGHTING & TECHNOLOGY CORPORATION, Yokosuka-shi, Kanagawa-ken (JP)

(21) Appl. No.: 14/005,301

(22) PCT Filed: Mar. 21, 2012
(86) PCT No.: PCT/JP2012/057239

§ 371 Date: Sep. 16, 2013

(30) Foreign Application Priority Data
Mar. 21, 2011 (CN) 201110078337.0

(51) Int. Cl. F21V 5/04

(52) U.S. Cl. CPC F21V 5/04
USPC 362/244

(57) ABSTRACT

A luminaire (11) includes a luminaire main body (21), an attachment plate (23), a plurality of light emitting modules (24), a plurality of lenses (25), and a lighting circuit (26). The luminaire main body (21) includes an opening (34) in a lower surface. The attachment plate (23) has a flat plate shape and is arranged in the luminaire main body (21), and a lower surface faces the opening (34). The plurality of light-emitting modules (24) include semiconductor light-emitting elements, and are attached to the lower surface of the attachment plate (23). The plurality of lenses (25) are provided for the respective light-emitting modules (24), and control luminous intensity distribution of light from the light-emitting modules (24). The lighting circuit (26) is arranged above the attachment plate (23) in the luminaire main body (21), and lights the light-emitting modules (24).

### TECHNICAL FIELD

An embodiment of the invention relates to a luminaire using a semiconductor light-emitting element as a light source.

### BACKGROUND ART

As a luminaire, there is a street light to illuminate a road. Some street lights use light-emitting modules including LED elements as light sources.

In this street light, a plurality of light-emitting modules are used in order to obtain a desired brightness. Further, the plurality of light-emitting modules are three-dimensionally arranged in order to obtain a desired luminous intensity distribution suitable for illuminating the road.

### CITATION LIST

### Patent Literature

PTL 1: Japanese Laid-open Patent Publication No. 2007-242258

### SUMMARY OF INVENTION

### Technical Problem

However, when the plurality of light-emitting modules are three-dimensionally arranged in order to obtain the desired luminous intensity distribution, there is a problem that the structure becomes complicated and becomes large.

A problem to be solved by the invention is to provide a luminaire in which a desired luminous intensity distribution can be obtained by using a plurality of light-emitting modules, and the structure can be made simple and small.

### Solution to Problem

According to an embodiment, a luminaire includes a luminaire main body, an attachment plate, a plurality of light-emitting modules, a plurality of lenses, and a lighting circuit. The luminaire main body includes an opening in a lower surface. The attachment plate has a flat plate shape and is arranged in the luminaire main body, and a lower surface faces the opening. The plurality of light-emitting modules include semiconductor light-emitting elements, and are attached to the lower surface of the attachment plate. The a plurality of lenses are provided for the respective light-emitting modules, and control luminous intensity distribution of light from the light-emitting modules. The lighting circuit is arranged in the luminaire main body and above the attachment plate, and lights the light-emitting modules.

### BRIEF DESCRIPTION OF DRAWINGS

FIG. 1 is a sectional view of a luminaire of an embodiment.

FIG. 2 is a perspective view in which light-emitting modules and lenses are attached to an attachment plate of the luminaire.

FIG. 3 is a perspective view in which the attachment plate Is attached to a luminaire main body of the luminaire.

FIG. 4 is a sectional view of the attachment plate and the lens of the luminaire.

FIG. 5 is a perspective view of the luminaire.

FIG. 6 is a perspective view of an installation state of the luminaire.

### DESCRIPTION OF EMBODIMENTS

Hereinafter, an embodiment will be described with reference to the drawings.

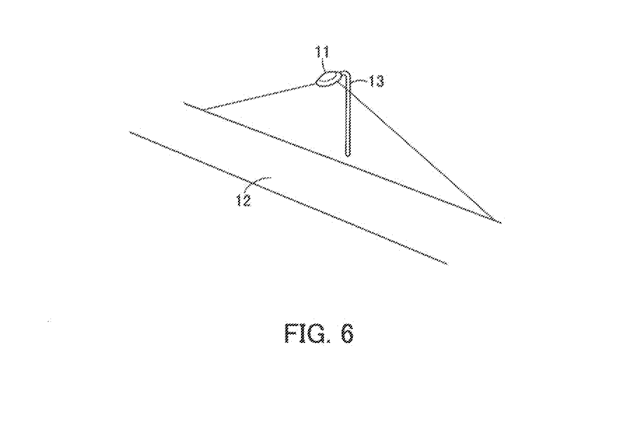

As shown in FIG. 6, as a luminaire 11, a street light for mainly illuminating a road 12 will be shown. This street light is attached to an upper end of a post 13 which is standingly provided on a side of the road 12 in its width direction, for example, on a road shoulder side, radiates light mainly to the center area of the road 12 from the road shoulder area of the road 12 and to an area with the street light as the center in a direction (running direction) along the road 12, and illuminates the road surface. Although FIG. 6 shows a state where the luminaire 11 is attached to the post 13, the upper end of which is bent horizontally toward the road 12 side, the luminaire may be attached to the post 13, the upper end of which extends vertically upward.

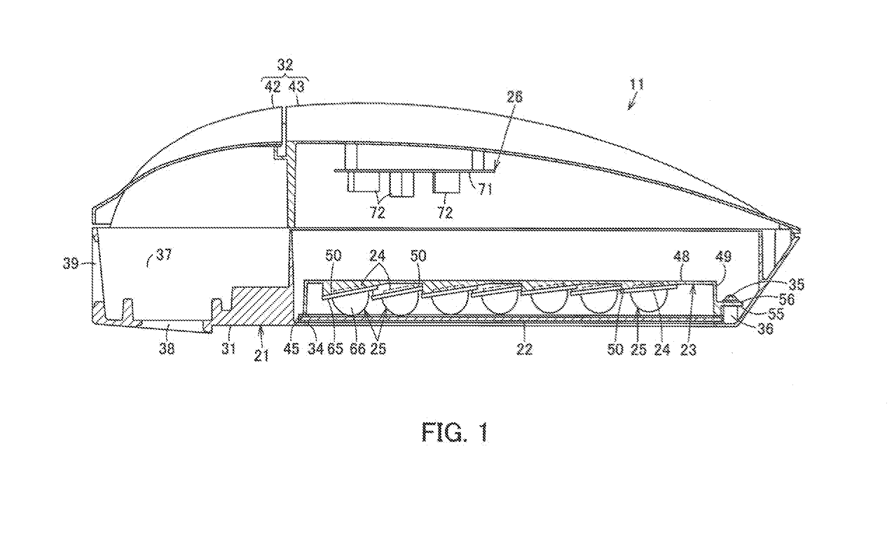

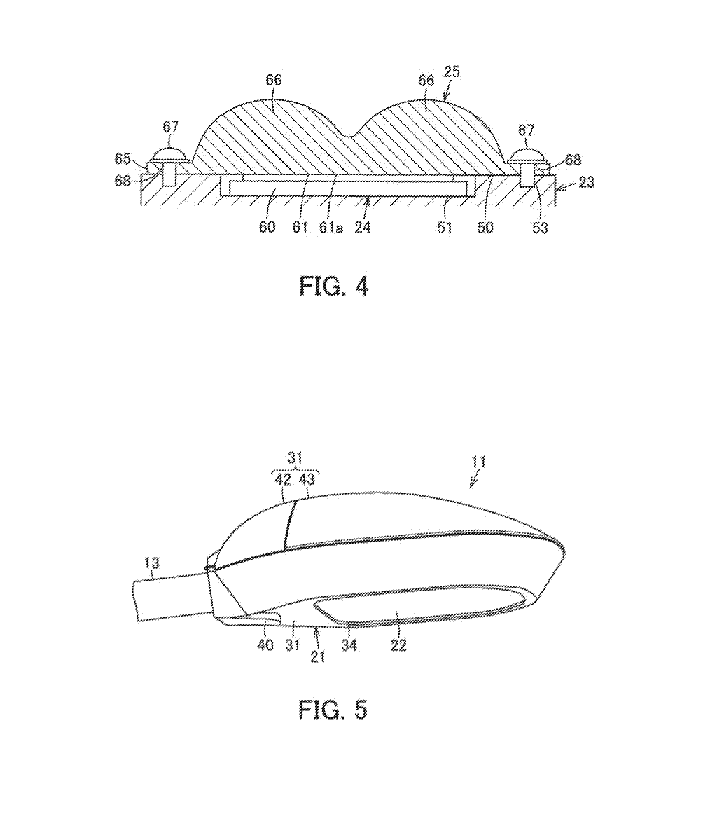

As shown in FIG. 1 to FIG. 5, the luminaire 11 includes a luminaire main body 21, a translucent cover 22 contained in the luminaire main body 21, an attachment plate 23, a plurality of light-emitting modules 24, a plurality of lenses 25 and a lighting circuit 26. Hereinafter, with respect to the luminaire 11, a side on which the luminaire is attached to the post 13 is rear, and the opposite side is front. Further, a direction in which the front and the rear are connected is a front and rear direction, and a direction orthogonal to the front and rear direction is a right and left direction.

The luminaire main body 21 includes a lower case 31 and an upper case 32, and these cases 31 and 32 are made of, for example, synthetic resin material or metal material such as aluminum.

An opening 34 for radiating light is formed in the lower surface of the lower case 31. A plurality of bosses 36 for attaching the attachment plate 23 by a plurality of screws 35 are provided on the inner surface side of the lower case 31 and in an edge part forming the opening 34.

A post attachment part 37 to be attached to the post 13 is formed on the rear side of the lower case 31. The post attachment part 37 includes attachment holes 38 and 39 formed in the lower surface and the rear surface on the rear side of the lower case 31. The end of the post 13 is inserted into the lower case 31 from one of the attachment holes 38 and 39, and the lower case 31 is attached to the end of the post 13 by a not-shown attachment unit in the lower case 31. In this embodiment, as shown in FIG. 5, attachment to the post 13 is performed by using the attachment hole 39 of the rear surface. The attachment hole 38 of the lower surface is not used, and the attachment hole 38 of the lower surface is closed by a cover 40. Incidentally, when the attachment hole 38 of the lower surface is used for the attachment to the post 13, the attachment hole 39 of the rear surface is closed by a similar cover.

The upper case 32 includes a rear case part 42 and a front case part 43, and is attached to the lower case 31 to be capable of opened and closed or attached and detached.

The translucent cover 22 is formed into a flat plate shape by using a material such as transparent or semi-transparent resin of glass. The outer shape of the translucent cover 22 is similar to the shape of the opening 34 of the lower case 31, and is formed to be slightly larger than the opening 34. A packing 45 is attached to the peripheral part of the translucent cover 22. The translucent cover 22 is inserted from the inside of the lower case 31, is arranged on the edge part forming the opening 34 of the lower case 31 and inside the plurality of bosses 36 through the packing 45, and closes the opening 34.

Besides, the attachment plate 23 is integrally formed into one substantially flat plate by using, for example, a metal material such as aluminum or a resin material excellent in heat conductivity. The outer shape of the attachment plate 23 is similar to the shape of the opening 34 of the lower case 31, and is formed to be slightly larger than the opening 34.

The attachment plate 23 includes a flat plate part 48 to which the plurality of light-emitting modules 24 and the plurality of lenses 25 are attached, and a peripheral wall part 49 protruding downward from the peripheral part of the flat plate part 48.

A plurality of attachment surface parts 50 to which the plurality of light-emitting modules 24 and the plurality of lenses 25 are respectively attached are integrally formed on the flat plate part 48 of the attachment plate 23. That is, a plurality of lines in each of which the plurality of attachment surface parts 50 are arranged side by side along the front and rear direction of the attachment plate 23 are formed. Besides, the respective attachment surface parts 50 in the lines adjacent to each other in the right and left direction are not arranged side by side in the right and left direction, bat are formed at positions shifted from each other in the front and rear direction. Among the attachment surface parts 50 in the plurality of lines, the number of the attachment surface parts 50 in the line on the center side is larger than the number of the attachment surface parts 50 in the line on both sides.

The plurality of attachment surface parts 50 are inclined to the irradiation direction of light emitted from the opening 34. In this embodiment, the attachment surface parts are inclined in the direction toward the front of the luminaire main body 21 and in the direction toward the center of the road 12. Further, the inclined angle of the rear side attachment surface part 50 is larger than the inclined angle of the front side attachment surface part 50. Incidentally, the inclined directions of the plurality of attachment surface parts 50 may be the same or different, and the inclined angles of the plurality of attachment surface parts 50 may be the same or different.

A recess part 51 in which the light-emitting module 24 is fitted and is positioned is formed in each of the attachment surface parts 50, and a pair of positioning holes 52 and a pair of attachment holes 53 are formed in the vicinity of both sides of the recess part 51. Further, a wiring hole 54 passing through the attachment plate 23 is formed in the vicinity of each of the attachment surface parts 50.

A flange 55 protrudes from the peripheral surface of the peripheral wall part 49 of the attachment plate 23 except for the rear surface side. A plurality of attachment holes 57 as attachment parts 56 for attachment to the plurality of bosses 36 of the lower case 31 by the screws 35 are formed in the flange 55. The attachment plate 23 is attached to the lower case 31, so that the translucent cover 22 is sandwiched and held between the lower case 31 and the peripheral wall part 49 of the attachment plate 23 through the packing 45.

Among the plurality of attachment surface parts 50 of the attachment plate 23, the respective attachment surface parts 50 positioned at the peripheral part and the respective attachment parts 56 of the flange 55 are respectively arranged at positions close to each other in one-to-one relation.

The inner surface of the attachment plate 23, that is, the lower surface of the flat plate part 48 and the inner peripheral surface of the peripheral wall part 49 are formed to be reflecting surfaces having high reflectivity. The reflecting surfaces are made mirror surfaces or are coated to be white, so that the reflectivity can be increased.

The light-emitting module 24 includes a board 60, a light-emitting part 61 formed on a surface as one surface of the board 60, and a connector 62 mounted on the surface of the board 60.

The board 60 is formed into a plate shape by using material, for example, metal such as aluminum excellent in heat conductivity, ceramic or the like.

The light-emitting part 61 includes a plurality of semiconductor light-emitting elements 63, such as LED elements or EL elements, mounted on the board 60. In this embodiment, the light-emitting module 24 is a COB (Chip On Board) module using LED elements as the semiconductor light-emitting elements 63. In the light-emitting module 24, the plurality of LED elements are arranged and mounted in matrix form on the board 60, the plurality of LED elements are electrically connected to each other, and a phosphor layer integrally covering the plurality of LED elements is formed. For example, in the case of an LED element emitting blue light, the phosphor layer is formed in such a way that silicone resin containing phosphor, which is excited by blue light emitted by the LED element and mainly emits yellow light, is filled in the inside of a surrounding part. By this, whitish light in which the blue light and the yellow light are mixed is emitted from a light-emitting surface 61a as a surface of the phosphor layer. Incidentally, the connector 62 is electrically connected to the plurality of LED elements.

The light-emitting module 24 is fitted in the recess part 51 formed in the attachment surface part 50 of the attachment plate 23, and is positioned and held by the attachment plate 23.

The lens 25 is made of, for example, transparent resin or glass. The lens 25 includes a base part 65 to be attached to the attachment surface part 50 of the attachment plate 23, and a pair of lens parts 66 provided to protrude from the base pert 65.

A pair of protrusions (not shown) to be fitted in the pair of positioning holes 52 of the attachment surface part 50 are provided on the base part 65, and a pair of insertion holes 68 for attachment to the attachment surface part 50 by a pair of screws 67 are provided. Each of the screws 67 is threaded into the attachment plate hole 53 of the attachment surface part 50 through the insertion hole 68, and the lens 25 is fastened and is fixed to the attachment surface part 50. At this time, the lens 25 contacts the light-emitting module 24 arranged in the recess part 51 of the attachment surface part 50, the light-emitting module 24 is sandwiched and held between the lens 25 and the recess part part 51 of the attachment surface part 50, and the light-emitting module 24 is pressure bonded to the attachment plate 23.

Each of the lens parts 66 is a convex lens hemispherically protruding from the base part 65, and the pair of lens parts 66 are arranged side by side in the right and left direction. By this, the lens 25 has a luminous intensity distribution characteristic to spread the light from the light-emitting module part 61 of the light-emitting module 24 in the right and left direction and a luminous intensity distribution characteristic to spread the light in the direction (running direction) along the road 12.

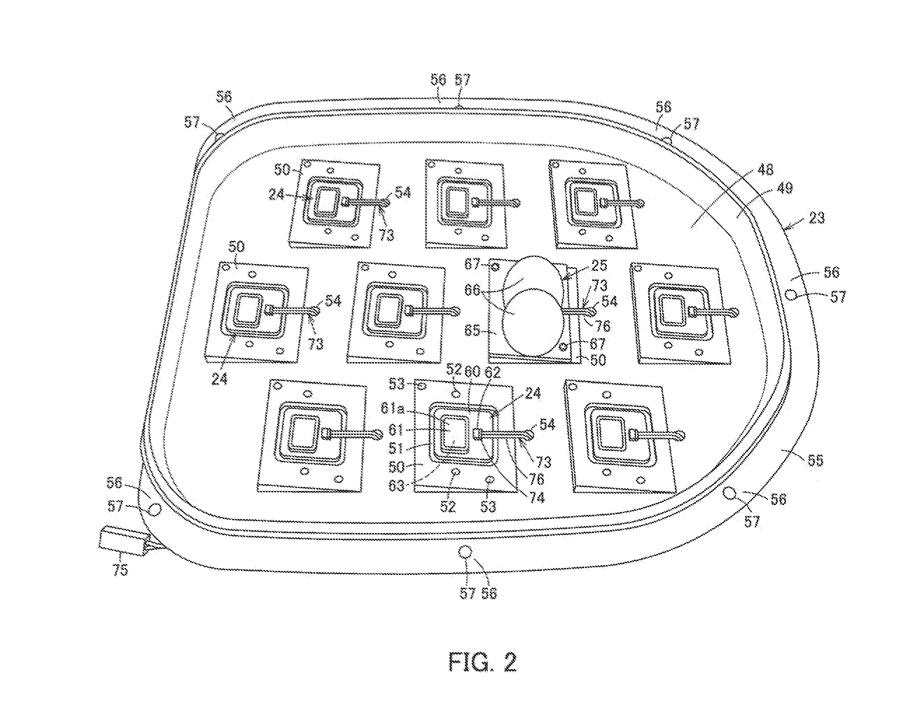

Incidentally, although FIG. 2 shows the one lens 25 attached to the one attachment surface part 50 correspondingly to the one light-emitting module 24, the lens 25 is attached to all the attachment surface parts 50 correspondingly to all the light-emitting modules 24.

The lighting circuit 26 receives, for example, AC power, Converts it into DC power, and supplies the power to the semiconductor light-emitting elements 63 of the respective light-emitting modules 24. The lighting circuit 26 includes a circuit board 71 and a plurality of circuit parts 72 mounted on the circuit board 71. The lighting circuit 26 is arranged above the attachment plate 23 in the luminaire main body 21, that is, is attached to the inside of the case part 43 of the upper case 32.

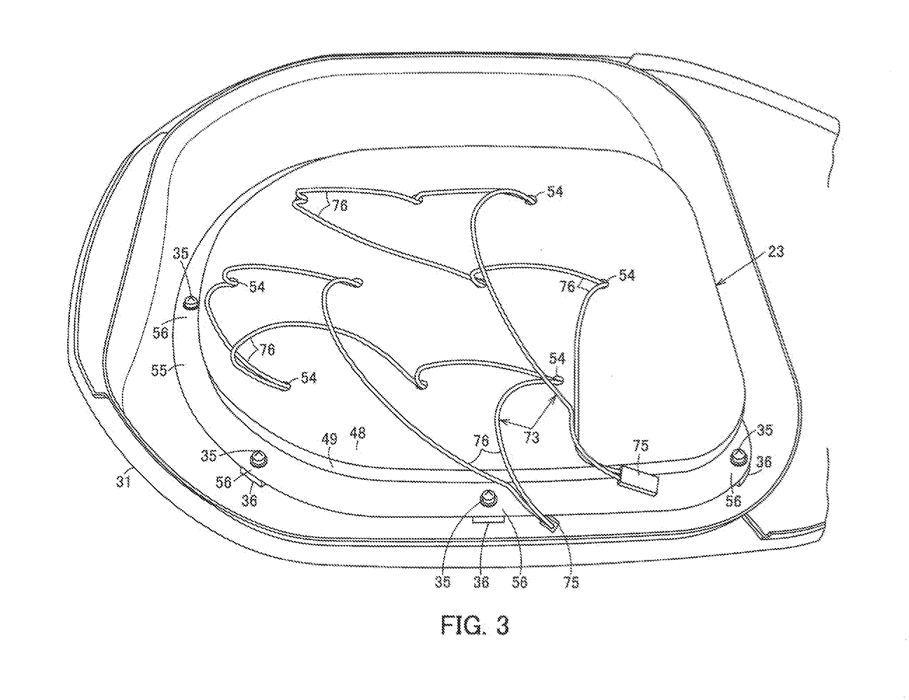

The respective light-emitting modules 24 are electrically connected to the lighting circuit 26 through a harness 73. The-harness 73 includes a plurality of connectors 74 connected to the plurality of light-emitting modules 24, A connector 75 connected to the lighting circuit 26, and electric wires 76 to sequentially connect the plurality of connectors 74 and the connector 75 in series. The respective connectors 74 are pulled out to the lower surface of the attachment plate 23 through the wiring holes 54 from the upper side of the attachment plate 23, and are connected to the connectors 62 of the respective light-emitting modules 24. In this embodiment, as shown in FIG. 3, the two harnesses 73 are used, and two series circuits are constructed in which the plurality of light-emitting modules 24 are connected in series for each of the harnesses 73.

Next, assembly of the luminaire 11 will be described.

The respective light-emitting modules 24 are fitted in and are attached to the recess parts 51 of the respective attachment surface parts 50 of the attachment plate 23. Further, the respective lenses 25 are arranged on the respective attachment surface parts 50, the screws 67 are threaded info the attachment holes 53 of the attachment surface parts 50 through the insertion holes 68 of the lenses 25, and the lenses 25 are fixed to the attachment surface parts 50. At this time, the lens 25 contacts the light-emitting module 24 arranged in the recess part 51 of the attachment surface part 50, the light-emitting module 24 is sandwiched and held between the lens 25 and the recess part 51 of the attachment surface part 50, and the light-emitting module 24 is pressure bonded to the attachment plate 23.

The respective connectors 74 of the harnesses 73 are led to the lower side of the attachment plate 23 through the wiring holes 54 from the upper side of the attachment plate 23, and are connected to the connectors 62 of the respective light-emitting modules 24.

The translucent cover 22 on which the packing 45 is mounted is arranged from the inside of the lower case 31 onto the edge part forming the opening 34 of the lower case 31 and inside the plurality of bosses 36, and the attachment plate 23 is put on the translucent cover 22. The plurality of screws 35 are threaded to the respective bosses 36 through the respective attachment holes 57 of the attachment plate 23, and the attachment plate 23 is fixed to the lower case 31. By this, the translucent cover 22 is sandwiched and held between the lower case 31 and the peripheral wall part 49 of the attachment plate 23 through the packing 45, and the opening 34 of the lower case 31 is liquid-tightly closed.

The connector 75 of the harness 73 is connected to the lighting circuit 26 attached to the case part 43 of the upper case 32, and the case part 43 is combined with the lower case 31. Further, the case part 42 of the upper case 32 is combined with the lower case 31.

Then, as shown in FIG. 6, the luminaire 11 is attached to the upper end of the post 13, a power supply line provided in the post 13 is electrically connected to the lighting-circuit 26 or the luminaire 11, and power can be supplied to the lighting circuit 26 through the power supply line.

The power is supplied to the lighting circuit 26 of the luminaire 11, so that the lighting circuit 26 supplies the lighting power to the respective light-emitting modules 24, and the light-emitting modules 24 are lit. The respective light-emitting modules 24 are lit, so that the light emitted from the light-emitting part 61 of each of the light-emitting modules 24 is incident on the lens 25, is controlled by the lens 25 to have a specified luminous intensity distribution, is emitted from the lens 25, passes through the translucent cover 22, is emitted from the opening 34 of the luminaire main body 21, and is irradiated to the road 12.

Each of the attachment surface parts 50 of the attachment plate 23 is inclined to the irradiation direction of light emitted from the opening 34, that is, each of the attachment surface parts 50 of the attachment plate 23 is inclined to the direction toward the front of the luminaire main body 21 and to the direction toward the center of the road 12. The light-emitting modules 24 and the lenses 25 attached to the attachment surface parts 50 are also similarly inclined. Thus, the light from the road shoulder side of the road 12 on which the luminaire 11 is installed to the center area of the road 12 is increased, and the center area of the road 12 separate from the luminaire 11 can also be illuminated.

Since the lens 25 has the luminous intensity distribution Characteristic to spread the light in the direction along the road 12, the wide range along the road 12 can be brightly illuminated.

The respective attachment surface parts 50 in the lines adjacent to each other in the right and left direction are not arranged side by side in the right and left direction, but are formed at positions shifted from each other in the front and rear direction. The light-emitting modules 24 and the lenses 25 attached to the attachment surface parts 50 are also not arranged side by side in the right and left direction, but are arranged at positions shifted from each other in the front and rear direction. Thus, the light emitted from the lens 25 to the right and left direction is not incident on the lens 25 in the adjacent line and is not blocked, and the desired luminous intensity distribution in the right and left direction can be obtained from the luminaire 11. That is, the wide range along the road 12 can be illuminated.

Accordingly, the luminaire 11 can illuminate the suitable range of the road 12 by devising the directions of the light-emitting modules 24 and the lenses 25, by devising the luminous intensity distribution characteristics of the lenses 25, and by devising the arrangement of the light-emitting modules 24 and the lenses 25.

Besides, since the structure is such that the plurality of light-emitting modules 24 and the plurality of lenses 25 are attached to the attachment plate 23 of the one flat plate, the structure can be made simple, and the assembling property can be improved.

There is a case where a desired luminous intensity distribution can hot be obtained only by attaching the plurality of light-emitting modules 24 and the plurality of lenses 25 to the one attachment plate 23. In that case, the attachment surface parts 50 are inclined to direct the light-emitting modules 24 and the lenses 25 attached to the attachment surface parts 50 in the light irradiation direction, or the luminous intensity distribution characteristics of the lenses 25 are adjusted, so that the desired luminous intensity distribution can be obtained.

Accordingly, according to the luminaire 11 of this embodiment, the desired luminous intensity distribution can be obtained by using the plurality of light-emitting modules 24, and the structure can be made simple and small.

Further, since the structure is adopted in which a plurality of light-emitting modules 24 and a plurality of lenses 25 are attached to the lower surface of the one flat-plate-shaped attachment plate 23 arranged in the luminaire main body 21, a space is formed above the attachment plate 23 in the luminaire main body 21, the lighting circuit 26 can be contained in the space, and the luminaire 11 can be made small.

Besides, since the light-emitting modules 24 adjacent to each other in the specified luminous intensity distribution direction, in which the luminous intensity distribution control is performed by the lens 25, are arranged at the positions shifted from each other in the luminous intensity distribution direction, the light emitted from the lens 25 to the specified luminous intensity distribution direction is not incident on the adjacent lens 25 and is not blocked, and the desired luminous intensity distribution can be obtained.

Besides, since the attachment surface parts 50 of the attachment plate 23 to which the light-emitting modules 24 are attached are inclined to the irradiation direction of light from the opening 34, the light directed toward the irradiation direction is increased, and the desired luminous intensity distribution can be obtained.

Besides, since the outer shapes of the opening 34 of the luminaire main body 21, the translucent cover 22 and the attachment plate 23 are formed to be similar to each other, the translucent cover 22 can be sandwiched and fixed between the luminaire main body 21 and the attachment plate 23. Thus, a dedicated structure for fixing the translucent cover 22 is not required, the whole periphery of the translucent cover 22 is sandwiched between the luminaire main body 21 and the attachment plate 23 by uniform pressure, and the waterproofing performance can be improved.

Besides, since the respective light-emitting modules 24 are arranged at the positions near the respective attachment parts 56 of the attachment plate 23, heat generated by the respective light-emitting modules 24 at the time of lighting can be efficiently conducted to the luminaire main body 21 through the respective attachment parts 56, and the temperature rise of the light-emitting module 24 can be suppressed. Incidentally, since the bosses 36 are provided on the luminaire main body 21 in order to attach the attachment plate 23, as compared with, for example, a case where an attachment portion for attaching the attachment plate 23 to the luminaire main body 21 is formed in a wide range along the outer shape of the attachment plate 23, the weight can be reduced. However, in order to improve the heat radiation property, the attachment portion for attaching the attachment plate 23 to the luminaire main body 21 may be provided in the wide range along the outer shape of the attachment plate 23.

Further, among the attachment surface parts 50 in the plurality of lines, the number of the attachment surface parts 50 in the line on the center side is larger than the number of the attachment surface parts 50 in the line on both sides. Also with respect to the light-emitting modules 24 and the lenses 25 attached to the attachment surface parts 50, the number of the attachment surface parts 50 in the line on the center side is larger than the number of the attachment surface parts 50 in the line on both sides. Thus, even if the shape of the attachment plate 23 is such that the length of the center of the attachment plate 23 is long in the front and rear direction, and the length between both sides off the attachment plate 23 is short, the heat of the attachment plate 23 can be uniformed.

Incidentally, in this embodiment, although the attachment surface parts 50 are inclined to the light irradiation direction relative to the flat plate part 48 of the attachment plate 23, the attachment surface parts 50 are formed in parallel to (flush with) the flat plate part 48 of the attachment plate 23, and the attachment plate 23 itself may be inclined to the light irradiation direction. Also in this case, the light from the road shoulder side of the road 12 on which the luminaire 11 is installed to the center area of the road 12 is increased, and the center area of the road 12 separate from the luminaire 11 can also be illuminated.

Besides, the luminaire 11 is not limited to the street light and can be used also for another illumination use.

While certain embodiments have been described, there embodiments have been presented by way of example only, and are not intended to limit the scope of the inventions. Indeed, the novel embodiments described herein may be embodied in a variety of the other forms; furthermore, various omissions, substitutions, and changes in the form of the embodied described herein may be made without departing from the spirit of the inventions. The accompanying claims and their equivalents are intended to cover such forms or modifications as would fall within the scope and spirit of the inventions.

### Reference Signs List

11 luminaire
21 luminaire main body
22 translucent cover
23 attachment plate
24 light-emitting module
25 lens
26 lighting circuit
34 opening
50 attachment surface part
56 attachment, part
63 semiconductor light-emitting element

1. A luminaire comprising:
a luminaire main body including an opening in a lower surface;
a flat-plate-shaped attachment plate which is arranged in the luminaire main body and a lower surface of which faces the opening;
a plurality of light-emitting modules including semiconductor light-emitting elements and attached to the lower surface of the attachment plate;
a plurality of lenses which are provided for the respective light-emitting modules and control luminous intensity distribution of light from the light-emitting modules; and
a lighting circuit which is arranged above the attachment plate in the luminaire main body, and lights the light-emitting modules.

2. The luminaire according to claim 1, wherein the light-emitting modules adjacent to each other in a specified luminous intensity distribution direction, in which luminous intensity distribution control is performed by the lenses, are arranged at positions shifted from each other in the luminous intensify distribution direction.

3. The luminaire according to claim 1, wherein the attachment plate includes attachment surface parts for attaching the light-emitting modules to the lower surface of the attachment plate, and the attachment surface parts are inclined to an irradiation direction of light from the opening.

4. The luminaire according to claim 1, wherein
the attachment plate includes a plurality of attachment parts to be attached to the luminaire main body, and
the light-emitting modules are respectively arranged at positions near the plurality of attachment parts of the attachment plate.

5. The luminaire according to claim 1, further comprising a translucent cover to cover the opening of the luminaire main body, wherein
outer shapes of the opening of the luminaire main body, the attachment plate and the translucent cover are similar, and the translucent cover is sandwiched and fixed between the luminaire main body and the attachment plate.
